(19) United States
(12) Patent Application Publication
(10) Pub. No.: US 2012/0222312 A1
(43) Pub. Date: Sep. 6, 2012

(54) ADJUSTABLE PEELER

(76) Inventor: Beata Bordas, Stuart, FL (US)

(21) Appl. No.: 13/039,886

(22) Filed: Mar. 3, 2011

(51) Int. Cl. A47J 17/02; A23L 1/212

(52) U.S. Cl. 30/123.6; 426/482

(57) ABSTRACT

An adjustable peeler with a peeler guide for controlling cutting depth while peeling a food article, such as, but not limited to, a fruit or vegetable, is disclosed. The peeler guide may be attached to a knife blade that may include a pair of apertures. The peeler guide may include a peeler blade for peeling the food article, at least two support legs, and a channel positioned in each support leg. The peeler guide may be secured to the knife blade with fasteners extending through the channels into the apertures in the knife blade. Additionally, the peeler guide may be adjustable such that the peeler guide is movable in a direction orthogonal to a longitudinal axis of the knife blade via each channel. Furthermore, the peeler guide may be offset from the knife blade such that a gap exists between the knife blade and the peeler guide.

### FIELD OF THE INVENTION

The present application relates to utensils and devices for peeling fruits, vegetables, and other food articles, and, more particularly, to an adjustable peeler.

### BACKGROUND

Often times, cooks, chefs, and others who prepare food spend a considerable amount of time and effort to prepare various types of foods, such as fruits and vegetables, for consumption. However, cooks and chefs often operate under time constraints, while also having to ensure high quality food is being provided to their customers. Accordingly, ensuring prompt and high quality food service often requires the use of efficient food preparation processes and handy and durable utensils. For example, peeling fruits and vegetables is a task that may take considerable time and effort to do properly, particularly if care is taken to not unnecessarily waste edible portions. Chefs and cooks may often use knives, peelers, or even expensive and complex peeling machinery that is tailored to peel only particular types of vegetables or fruit. Additionally, after using such utensils and machinery, inedible or undesirable remnants may still be left behind which must be removed by hand afterwards. Furthermore, although traditional knives may provide a rapid and effective means for peeling food, it is often difficult to maintain a consistent peeling thickness when peeling fruits, vegetables, or other foods. Thus, a need exists for providing utensils and methods for peeling foods that ensure rapid, yet consistent results.

### SUMMARY

An adjustable peeler for peeling fruits, vegetables, and other food articles is disclosed. The adjustable peeler may include a handle, a knife blade, and a peeler guide that may be connected to the knife blade. The peeler guide may be connected to the knife blade via a pair of apertures existing on the knife blade through the use of one or more types of fasteners. Once connected to the knife blade, a peeler blade of the peeler guide may be offset from the knife blade so as to allow the adjustable peeler to perform a peeling function. After the peeler guide is securely fastened to the knife blade of the adjustable peeler, a user may then peel various foods by positioning the peeler blade of the peeler guide against the surface of the particular food and then using a peeling motion to peel the food. If the user desires to peel different foods that may have different thicknesses of peel, the user may adjust the positioning of the peeler guide with respect to the knife blade such that the offset of the peeler blade with respect to the knife blade is increased or decreased accordingly.

In one embodiment, an adjustable peeler may be provided. The adjustable peeler may include a handle for forming a proximal end of the adjustable peeler. Additionally, the adjustable peeler may include a knife blade having a cutting arris. The knife blade may be attached to a distal end of the handle and may include a pair of apertures. The adjustable peeler may further include a peeler guide for peeling a food article, which may include a peeler blade for peeling the food article and at least two support legs. The peeler guide may also include at least one channel that may be positioned in each support leg of the peeler guide. The peeler guide may be secured to a side of the knife blade of the adjustable peeler such that at least a portion of each of the at least one channel may be aligned with the apertures of the knife blade and a pair of fasteners extend through the at least one channel in the peeler guide and at least partially into the apertures of the knife blade. Furthermore, the peeler guide may be adjustable such that the peeler guide may be movable in a direction orthogonal to a longitudinal axis of the knife blade via the at least one channel. Moreover, the peeler guide may be offset from the knife blade such that a gap exists between the cutting arris and the peeler guide.

In another embodiment, a method for utilizing an adjustable peeler may be provided. The method may include positioning the adjustable peeler proximate to a food article. The adjustable peeler may include a knife blade having a cutting arris and the knife blade may be attached to a distal end of the handle and may include a pair of apertures. The adjustable peeler may also include a peeler guide for peeling the food article. The peeler guide may include a peeler blade for peeling the food article and at least two support legs. Additionally, at least one channel may be positioned in each support leg of the peeler guide. The peeler guide may be secured to a side of the knife blade of the adjustable peeler such that at least a portion of each of the at least one channel may be aligned with the apertures of the knife blade and a pair of fasteners extend through the at least one channel in the peeler guide and at least partially into the apertures of the knife blade. The peeler guide may be adjustable such that the peeler guide may be movable in a direction orthogonal to a longitudinal axis of the knife blade via the at least one channel. Furthermore, the peeler guide may be offset from the knife blade such that a gap exists between the cutting arris and the peeler guide. The method may also include positioning the peeler guide against a surface of the food article such that the peeler blade is adjacent to the surface of the food article. Additionally, the method may include peeling the food article such that the cutting arris of the knife blade cuts into the food article and the peeler guide limits a depth of cutting by the knife blade using the peeler blade of the peeler guide. The method may further include adjusting the peeler guide of the adjustable peeler such that the offset of the peeler blade of the peeler guide from the knife blade is suitable for a different food article.

According to another exemplary embodiment, another adjustable peeler may be provided. The adjustable peeler may include a handle and a knife blade having a cutting arris and attached to a distal end of the handle. The knife blade may include apertures. The adjustable peeler may also include a peeler guide, which may include a peeler blade and support legs. Also, the peeler guide may include at least one channel that may be positioned in each support leg of the peeler guide. The peeler guide may be secured to the knife blade of the adjustable peeler such that at least a portion of the at least one channel may be aligned with the apertures of the knife blade and fasteners extend through the at least one channel in the peeler guide and at least partially into the apertures of the knife blade. Furthermore, the peeler guide may be adjustable such that the peeler guide may be movable in a direction perpendicular to the knife blade via the at least one channel.

These and other features of the adjustable peeler are described in the following detailed description, drawings, and appended claims.

### BRIEF DESCRIPTION OF THE DRAWINGS

FIG. 1 is a perspective view of an adjustable peeler featuring a knife blade, handle and peeler guide.

FIG. 2 is a side view of the adjustable peeler of FIG. 1.

FIG. 3 is an exploded side view of the adjustable peeler.

FIG. 4 is a cross-sectional view of the peeler guide of FIG. 1 taken at section line 4-4.

FIG. 5 illustrates a knife guard that may be attached to the adjustable peeler.

FIG. 6 illustrates a can opener that may be attached to the adjustable peeler.

FIG. 7 illustrates a bottle opener that may be attached to the adjustable peeler.

FIG. 8 is a method for peeling food articles by utilizing an adjustable peeler.

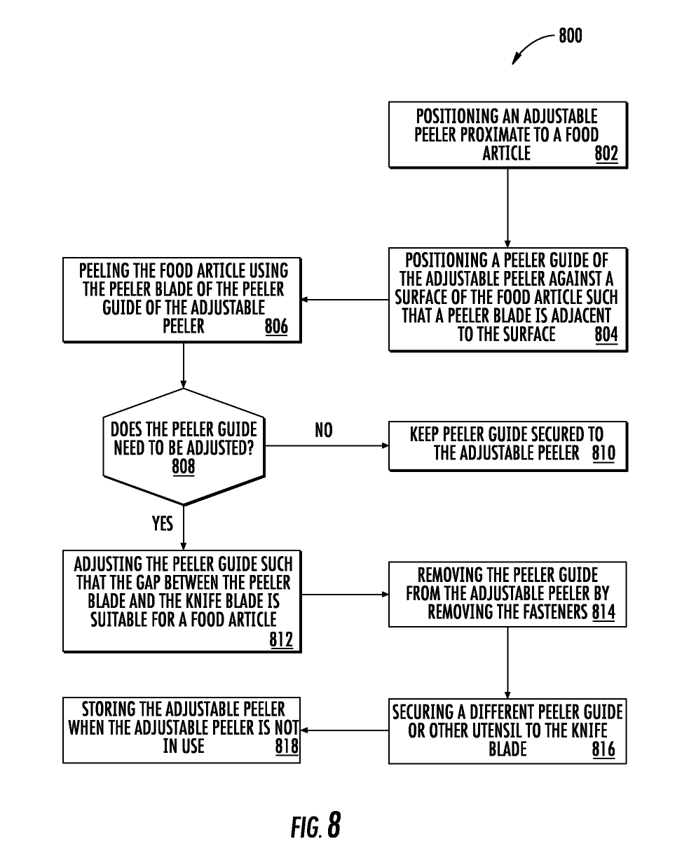

### DETAILED DESCRIPTION OF THE INVENTION

The exemplary embodiments of the present disclosure are described with respect to an adjustable peeler for peeling different types of food, such as, but not limited to, fruits and vegetables. The adjustable peeler may be configured to include a handle, a knife blade, and a peeler guide. In order to utilize the adjustable peeler, the peeler guide may be attached to a portion of the knife blade by using fasteners to connect to apertures in the knife blade. A peeler blade of the peeler guide may be offset from the knife blade when the peeler guide is secured to the knife blade. The offset enables a user to effectively peel various food items. The peeler blade of the adjustable peeler may then be positioned against the surface of a food item that the user wishes to peel and then the user may use a peeling motion to peel the food item. Once the user is done peeling the food item, the user may wish to peel a different food item that may require a different offset. As a result, the user may then adjust the positioning of the peeler guide with respect to the knife blade such that the requisite offset is attained.

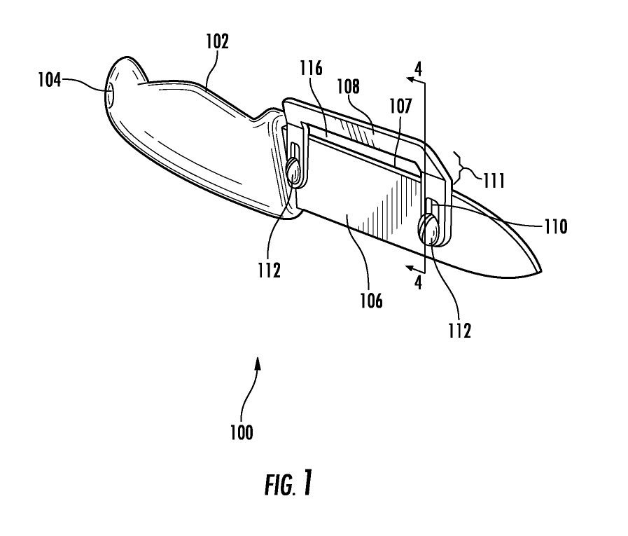

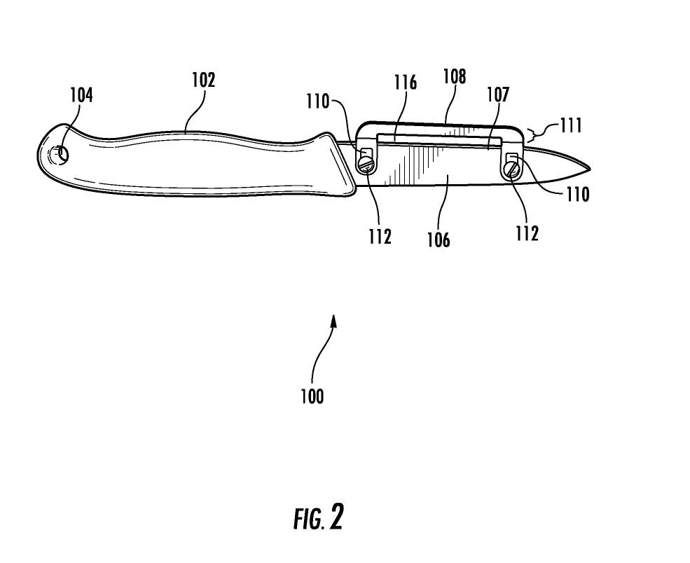

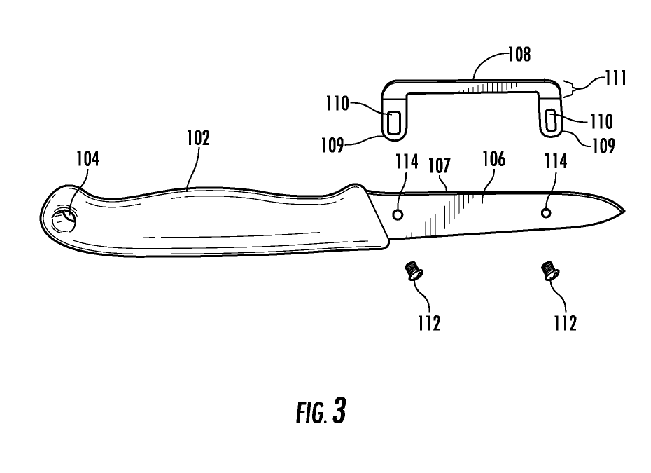

As shown in FIGS. 1-4, an exemplary adjustable peeler 100 for peeling a food article is schematically illustrated. The adjustable peeler 100 may include a handle 102 for forming a proximal end of the adjustable peeler 100. The handle 102 may be, but is not limited to being formed from, stainless steel, rubber, various types of plastics, wood, other metals, or other suitable materials. The grip of the handle 102 may be ergonomically constructed so as to easily fit in a user's hand. Additionally, the handle 102 may include a hole 104 positioned at a proximal end of the handle 102. The hole 104 may be utilized to hang the adjustable peeler 100 by the handle 102 when the adjustable peeler 100 is not in use. For example, a storage device may include a rod that may be inserted through the hole 104 so as to keep the adjustable peeler 100 in position. Similarly, another storage device may include clasps, clamps, ties, or another type of fastener that can fasten around the hole 104 of the handle 102 to secure the adjustable peeler 100 in place. The adjustable peeler 100 may also include a knife blade 106 that may include a cutting arris 107. The knife blade 106 may be attached to a distal end of the handle 102. Also, the knife blade 106 may be made of various types of materials such as, but not limited to, stainless steel, other metals, plastics, or other materials.

Also, the knife blade 106 may include a pair of openings or apertures 114. The apertures 114 may be of various sizes and shapes. Although FIGS. 1-4 illustrate two apertures 114, one, three or more apertures 114 may be utilized as well. The positioning of the apertures 114 with respect to one another may also be changed based on the type of attachment to be connected to the knife blade 106. In addition to having the knife blade 106, the adjustable peeler 100 may also include a peeler guide 108. In an embodiment, the peeler guide 108, may be a u-shaped attachment as illustrated in FIGS. 1-4, however, other shapes and configurations are also contemplated. A u-shaped attachment may include a gap 116 between either end of the peeler guide 108, as illustrated in the figures. Additionally, the peeler guide 108 may be made of various materials such as, but not limited to, stainless steel, other metals, or other suitable materials. Notably, the peeler guide 108 may include one or more support legs 109, a peeler blade 111, and tracks or channels 110. As illustratively shown in the figures, the peeler guide 108 includes a channel 110 positioned in each support leg 109 of the peeler guide 108, however, any number of legs 109 or channels 110 may be utilized. In a preferred embodiment, the peeler guide 108 may be approximately two inches long and a half an inch wide. Other dimensions are also contemplated.

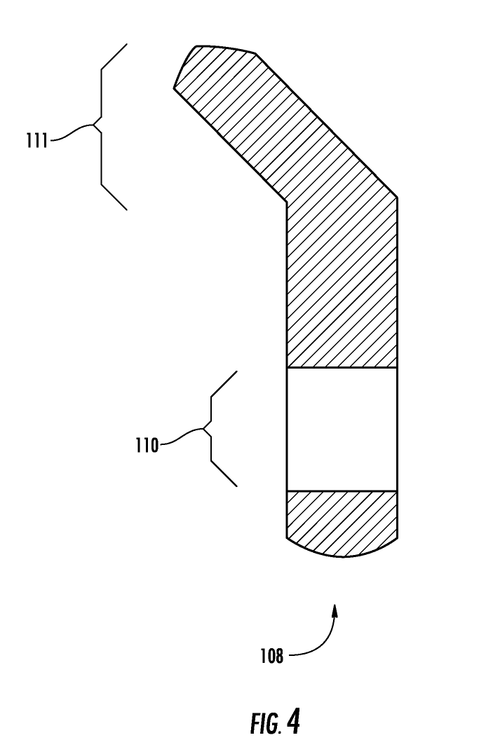

As shown in FIG. 4, a distal blade portion 111 of the peeler guide 108 at a distal end of the peeler guide 108 may extend at an acute angle from a plane in which a remainder of the peeler guide 108 resides in such a way so as to enable the peeler blade 111 to peel the food article when the peeler blade 111 is placed against a surface of the food article. The peeler guide 108 may be attached to the knife blade 106. For example, the peeler guide 108 may be attached on one side of the knife blade 106 for right-handed users or on the other side of the knife blade 106 for left-handed users. The peeler guide 108 may be attached to the knife blade by aligning a portion of the channels 110 over the apertures 114 of the knife blade 106. For example, as shown in FIG. 1, the bottom portions of the channels 110 are aligned with the apertures 114. Once aligned, the peeler guide 108 may be attached to the knife blade 106 by utilizing fasteners 112. The fasteners 112 may be extended through the apertures 114 and through the portion of the channels 110 aligned with the apertures 114 to fasten the knife blade 106 and peeler guide 108 together. The fasteners 112 may include, but are not limited to, screws, clasps, ties, magnets, clips, or other types of fasteners.

The position of the peeler guide 108 with respect to the knife blade 106 may be determined by which portion of the channels 110 is aligned with the apertures 114 of the knife blade 106. The position of the peeler guide 108 may also determine the gap 116 of the peeler blade 111 with respect to the cutting arris 107 of the knife blade 106. The gap 116 may be the portion of the space between the peeler guide 108 and the knife blade 106. The peeler guide 108 and the gap 116 may be adjusted by the user so as to peel different types of foods. As shown in FIG. 1, if the very bottom portion of the channels 110 are aligned with the apertures 114, a greater gap 116 may be created than if another portion of the channels 110 are aligned with the apertures 116. The smallest gap 116 may be created when the very top portion of the channels 110 are aligned with the apertures 116.

In order to adjust the peeler guide 108, the fasteners 112 may be removed or loosened to allow the peeler guide 108 to be adjusted. The peeler guide 108 may be movable in a direction orthogonal to a longitudinal axis of the knife blade 106 via the channels 110. Once removed or adjusted, the position of the channels 110 with respect to the apertures 114 may be adjusted and then the fasteners 112 may be utilized to reattach the peeler guide 108 to the knife blade 106. This provides a convenient manner in which the user can easily adjust the peeler guide 108 based on the type of food the user wants to peel. For example, a thicker peel may require a larger gap 116, and a food with a thinner peel may require a smaller gap 116. In an embodiment, the peeler guide 108 may be secured on the other side of the knife blade 106 or even on the handle 102 of the adjustable peeler 100. In another embodiment, if one peeler guide 108 is secured to one side of the knife blade 106, another peeler guide 108 may be attached to the other side of the knife blade 106 so that multiple attachments are possible simultaneously.

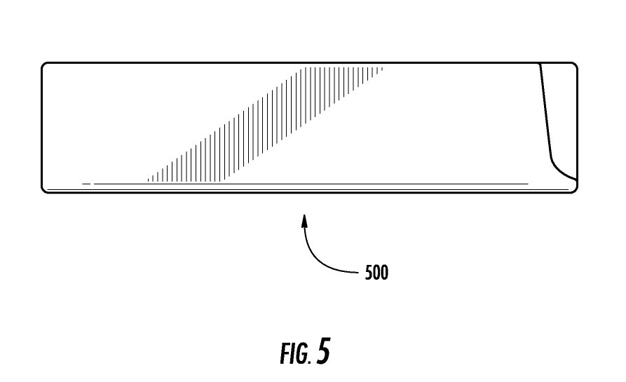

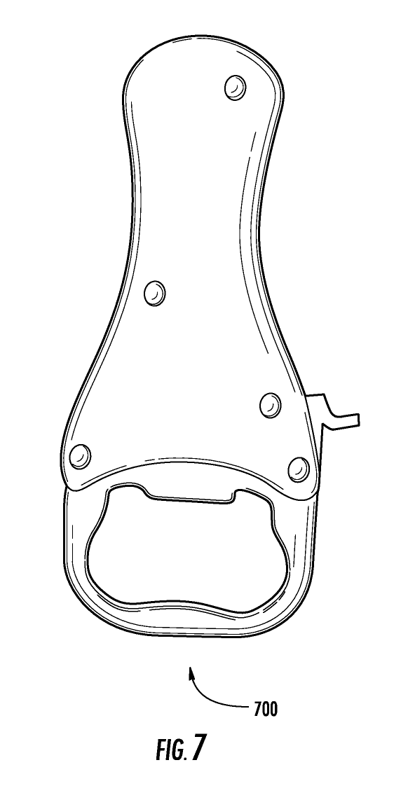

In yet another embodiment, other types of attachments may be attached to the knife blade 106. For example as shown in FIGS. 5-7, another knife blade 106, a knife guard 500, a can opener 600, a bottle opener 700, or any other suitable utensil may be attached to the knife blade 106 via the apertures 114 or through other means. In one embodiment, the adjustable peeler 100 may be fitted with components that allow the adjustable peeler 100 to attach to a magnet so as to secure the adjustable peeler 100 when it is not being used. For example, a portion of the adjustable peeler 100 may be ferromagnetic such that the adjustable peeler 100 may be attached to a magnet for storage. In another embodiment, the knife blade 106 or even the handle 102 may include additional apertures for attaching additional utensils to various portions of the adjustable peeler 100. In yet another embodiment, the width of the peeler blade 111 of the peeler guide 108 may be configured to be equal to the width between the apertures 114 of the knife blade 106. In still another embodiment, instead of using apertures 114, other mechanisms may be utilized to attach the peeler guide 108 to the adjustable peeler 100. For example, the peeler guide 108 may be clamped onto the knife blade 106 itself, locked onto the knife blade 108 using a locking mechanism, fixed onto the knife blade 106, attached using a snap-in adaptor mechanism, or a variety of other suitable attachment mechanisms. In a preferred embodiment, the adjustable peeler 100 may have an overall length of five to six inches, however, other lengths are also contemplated. Notably, the adjustable peeler 100 may be manufactured by existing methods of production such as, but not limited to, plastic injection molding, stamping, extrusion, or other similar forming methods or via methods that are developed after creation of the invention.

In operation, a user may attach the peeler guide 108 to the knife blade 106 by first sliding the peeling attachment 108 up or down such that a portion of the tracks or channels 110 of the peeling attachment 108 are aligned with the apertures 114 of the knife blade 106. The user may then fasten the peeler guide 108 to the knife blade 106 using any one of a variety of fasteners 112. Once peeler guide 108 is fastened, the user may then proceed to peel a food item. After the user is finished peeling the food item, the user may adjust the peeler guide 108 to peel foods that may require different offsets 116 to effectively peel them. When the user is done using the adjustable peeler 100, the user may then simply remove the fasteners 112 to detach the peeler guide 108 from the adjustable peeler 100. The user may then easily wash the various components of the adjustable peeler 100 and either decide to reattach the components or leave the components separate. The user may then store the adjustable peeler 100 away for future use.

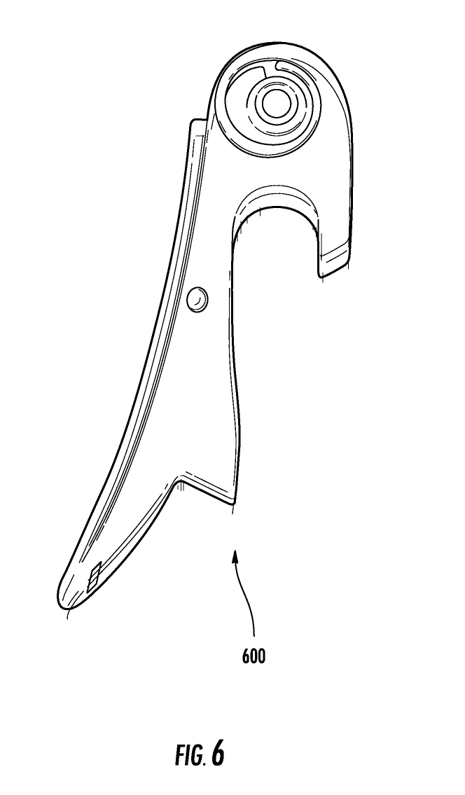

Referring now also to FIG. 6, an exemplary method 600 for utilizing an adjustable peeler to peel food articles is illustrated. The method 600 may include, at step 602, positioning the adjustable peeler 100 proximate to a food article. The adjustable peeler 100 may include a knife blade 106 having a cutting arris 107 that may be attached to a distal end of the handle 102 of the adjustable peeler 100. The knife blade 106 may also include apertures 114. The adjustable peeler 100 may also include a peeler guide 108 that may be utilized for peeling the food article. Also, the peeler guide 108 may include at least two support legs 109 and one or more channels 110. The one or more channels 110 may be positioned in each support leg 109 of the peeler guide 108 such that at least a portion of each of the channels 110 is aligned with the apertures 114 of the knife blade 106. The peeler guide 108 may be attached to the knife blade 106 by extending fasteners 112 through the one or more channels 110 in the peeler guide 108 and at least partially into the apertures 114 of the knife blade 106.

The method 600 may also include, at step 604, positioning the peeler guide 108 against a surface of the food article such that the peeler blade 111 is adjacent to the surface of the food article. This allows a user to be in a position to peel the food article using the adjustable peeler 100. The method 600, at step 606, may further include peeling the food article using the peeler blade 111 of the peeler guide 108 of the adjustable peeler 100. Because the gap between the peeler blade 111 with respect to the knife blade 106 is maintained by the fasteners 112, the adjustable peeler will peel various foods evenly and efficiently. At step 608, the method 600 may include determining if the peeler guide 108 of the adjustable peeler 100 needs to be adjusted. If it is determined that the peeler guide 108 does not need to be adjusted, the method 600 may include keeping the peeler guide 108 secured to the adjustable peeler 100 in its current position at step 610. If, however, it is determined that the adjustable peeler 100 needs to be adjusted, the method 600 may include adjusting the peeler guide 108 such that the gap between the peeler blade 111 and the knife blade 106 is suitable for another food article at step 612. For example, if a user determines that the current offset or gap of the peeler blade 111 is insufficient to peel a different food item, the user may adjust the offset of the peeler blade 111 such that the offset or gap is increased or decreased accordingly.

Optionally, the method 600 may include removing the peeler guide 108 from the adjustable peeler 100 by removing the fasteners 112 from the apertures 114 of the knife blade 106 and the channels 110 of the peeler guide 108 at step 614. A user may then use the adjustable peeler 100 as a traditional knife when the peeler guide 108 is removed. As a further option, the method 600, at step 616, may include securing a different peeler guide 108 or another type of attachment to the knife blade 106 or to another portion of the adjustable peeler 100. For example, a larger or smaller peeler guide, a knife guard 500, a can opener 600, a bottle opener 700, or another type of utensil may be attached to either side of the knife blade 106 or even to a portion of the handle 102. In an embodiment, multiple attachments may be attached to the adjustable peeler 100 at a time. At step 618, the method 600 may include storing the adjustable peeler 100 when the adjustable peeler 100 is not in use. For example, the handle 102 of the adjustable peeler 100 may include a hole 104 positioned near an end of the adjustable peeler 100. A storage device including a fastener or other component that can attach to the handle 102 via the hole 104 may allow the adjustable peeler to be stored securely.

Accordingly to an embodiment, a method for assembling and disassembling an adjustable peeler 100 may also be provided. The method may include attaching an end of a handle 102 to an end of a knife blade 106. The handle 102 may be attached to the end of the knife blade 106 by fusing the handle 102 to the knife blade 106, by using clasps, by using a lock mechanism, or by using other attachment means. As noted above, the knife blade 106 may include one or more apertures 114 that may be utilized for securing various attachments. The method may also include aligning a portion of the channels of a peeler guide 108 over the apertures 114 of the knife blade 106. Once aligned, the method may include positioning or extending one or more fasteners 112 through the portion of the channels 110 aligned with the apertures 114 and through the apertures 114 of the knife blade 106 itself. The method may include fastening the fasteners 112 accordingly. The fasteners 112, for example, may include, but are not limited to, screws, clasps, clamps, wedges, ties, locks, or other fastening mechanisms for securing the peeler guide 108 to the knife blade 106. Once the peeler guide is fastened to the knife blade 106, the peeler blade 111 of the peeler guide 108 may be offset from the knife blade 106 so as to allow peeling of various items.

After the peeler guide 108 is fastened to the knife blade 106 and a user is finished utilizing the adjustable peeler 100, the method may include removing the peeler guide 108 from the knife blade 106 by removing or unclasping the fasteners 112. The method may then include fastening a different peeler guide or a different utensil to the knife blade 106. For example, a knife guard 500, a can opener 600, a bottle opener 700, a larger or smaller peeler guide, or other types of utensils may be attached to the knife blade 106 or to other portions of the adjustable peeler 100. If, however, the user does not want to remove the peeler guide 108, but instead merely wants to adjust it, the user may adjust the peeler guide 108 by removing the fasteners 112 and changing the alignment of the channels 110 with respect to the apertures 114 of the knife blade 106. For example, the channels 110 may be designed to be larger than the apertures 114 of the knife blade 106 such that the portion of the channel 110 that is aligned and secured with the aperture 114 of the knife blade 106 may be changed depending on what blade offset the user desires.

The adjustable peeler 100 may be provided as a kit to various users. The kit may separately include any of the fasteners 112 described herein, the handle 102, the knife blade 106, the peeler guide 108, and any other suitable accessories. The knife blade 106 and handle 102 may be already attached when provided in the kit. The kit may also include utensils such as screwdrivers or other similar utensils for attaching or removing the peeler attachment from the adjustable peeler. Furthermore, it is important to note that the methods described above may incorporate any of the functionality, components, and/or features of the adjustable peelers described above and are not intended to be limited to the description provided above.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. An adjustable peeler, comprising:
a handle for forming a proximal end of the adjustable peeler;
a knife blade having a cutting arris and a pair of apertures, wherein the knife blade is attached to a distal end of the handle; and
a peeler guide for peeling a food article and including:
a peeler blade for peeling the food article;
at least two support legs; and
at least one channel positioned in each support leg of the peeler guide;
wherein the peeler guide is secured to a side of the knife blade of the adjustable peeler such that at least a portion of each of the at least one channel is aligned with the apertures of the knife blade and a pair of fasteners extend through the at least one channel in the peeler guide and at least partially into the apertures of the knife blade;
wherein the peeler guide is adjustable such that the peeler guide is movable in a direction orthogonal to a longitudinal axis of the knife blade via the at least one channel; and
wherein the peeler guide is offset from the knife blade such that a gap exists between the cutting arris and the peeler guide.

2. The adjustable peeler of claim 1, wherein a size of the gap between the cutting arris and the peeler guide is adjustable by moving the peeler guide in a direction that is generally orthogonal to the cutting arris.

3. The adjustable peeler of claim 1, wherein the peeler attachment is removable by removing the fasteners from the peeler guide and the knife blade.

4. The adjustable peeler of claim 1, wherein the apertures in the knife blade extend through the knife blade such that the peeler guide is attachable to either side of the knife blade via the apertures in the knife blade.

5. The adjustable peeler of claim 1, wherein a distal portion of the peeler guide at a distal end extends at an acute angle from a plane in which a remainder of the peeler guide resides.

6. The adjustable peeler of claim 1, wherein the handle of the adjustable peeler further comprises a hole at a proximal end of the handle, enabling the adjustable peeler to be stored by positioning a secured object through the hole.

7. The adjustable peeler of claim 1, wherein at least a portion of the adjustable peeler is ferromagnetic such that the adjustable peeler is attached to a magnet for storage.

8. The adjustable peeler of claim 1, wherein the fasteners are selected from one of the group consisting of a pair of screws, a pair of clasps, a pair of ties, a pair of magnets, and a pair of clips.

9. The adjustable peeler of claim 1, further comprising an alternative peeler attachment, wherein the alternative peeler attachment is selected from the group consisting of a guard, a can opener, and a bottle opener attached to the knife blade via the apertures in the knife blade.

10. The adjustable peeler of claim 1, wherein the adjustable peeler comprises additional apertures for attaching additional utensils to the adjustable peeler.

11. The adjustable peeler of claim 1, wherein a width of the peeler blade is equal to a width between the pair of apertures of the knife blade.

12. A method for utilizing an adjustable peeler, the method comprising:
positioning the adjustable peeler proximate to a food article, wherein the adjustable peeler includes;
a knife blade having a cutting arris and attached to a distal end of the handle and including a pair of apertures; and
a peeler guide for peeling the food article, including:
a peeler blade for peeling the food article;
at least two support legs; and
at least one channel positioned in each support leg of the peeler guide, wherein the peeler guide is secured to a side of the knife blade of the adjustable peeler such that at least a portion of each of the at least one channel is aligned with the apertures of the knife blade and a pair of fasteners extend through the at least one channel in the peeler guide and at least partially into the apertures of the knife blade;
wherein the peeler guide is adjustable such that the peeler guide is movable in a direction orthogonal to a longitudinal axis of the knife blade via the at least one channel; and
wherein the peeler guide is offset from the knife blade such that a gap exists between the cutting arris and the peeler guide.
positioning the peeler guide against a surface of the food article such that the peeler blade is adjacent to the surface of the food article;
peeling the food article such that the cutting arris of the knife blade cuts into the food article and the peeler guide limits a depth of cutting by the knife blade using the peeler blade of the peeler guide; and
adjusting the peeler guide of the adjustable peeler such that the offset of the peeler blade of the peeler guide from the knife blade is suitable for a different food article.

13. The method of claim 12, further comprising removing the peeler guide from the knife blade by removing the fasteners from the knife blade.

14. The method of claim 12, further comprising securing an alternative peeler attachment, wherein the alternative peeler attachment is selected from the group consisting of a guard, a can opener, and a bottle opener attached to the knife blade via the apertures in the knife blade.

15. The method of claim 12, further comprising storing the adjustable peeler by positioning a portion of a hanging device into a hole in a handle of the adjustable peeler when the adjustable peeler is not in use.

16. An adjustable peeler comprising:
a handle;
a knife blade having a cutting arris and attached to a distal end of the handle and including apertures; and
a peeler guide including:
a peeler blade;
support legs; and
at least one channel positioned in each support leg of the peeler guide,
wherein the peeler guide is secured to the knife blade of the adjustable peeler such that at least a portion of the at least one channel is aligned with the apertures of the knife blade and fasteners extend through the at least one channel in the peeler guide and at least partially into the apertures of the knife blade; and
wherein the peeler guide is adjustable such that the peeler guide is movable in a direction perpendicular to the knife blade via the at least one channel.

17. The adjustable peeler of claim 16, wherein the peeler guide is offset from the knife blade such that a gap exists between the cutting arris and the peeler guide.

18. The adjustable peeler of claim 16, wherein the knife blade and the peeler guide consist of stainless steel and the handle consists of a material selected from the group consisting of plastic and rubber.

19. The adjustable peeler of claim 16, further comprising an alternative peeler attachment, wherein the alternative peeler attachment is selected from the group consisting of a guard, a can opener, and a bottle opener attached to the knife blade via the apertures in the knife blade.

20. The adjustable peeler or claim 17, wherein a size of the gap between the cutting arris and the peeler guide is adjustable by moving the peeler guide in a direction that is generally perpendicular to the cutting arris.
